(19) United States
(12) Patent Application Publication
(10) Pub. No.: US 2020/0130925 A1
(43) Pub. Date: Apr. 30, 2020

(54) CAPSULE

(71) Applicants: Paul WIEDERMANN, Muenchen (DE); Mick WIEDERMANN, Muenchen (DE)

(72) Inventors: Paul WIEDERMANN, Muenchen (DE); Mick WIEDERMANN, Muenchen (DE)

(21) Appl. No.: 16/627,048

(22) PCT Filed: Jan. 4, 2018
(86) PCT No.: PCT/IB2018/000004

§ 371 Date: Dec. 27, 2019

(30) Foreign Application Priority Data
Jul. 12, 2017 (DE) 20 2017 003 653.3

(51) Int. Cl. B65D 85/804

(52) U.S. Cl. CPC B65D 85/8043; A47J 31/4489

(57) ABSTRACT

A capsule containing a beverage powder for preparing a portion of a hot brewed beverage has an inflow chamber provided in the region of the base, the inflow chamber being delimited from the interior by a partition wall which is near the base and remote from the cover such that the interior has a central tube that runs in an upright manner relative to the base, a hollow cylindrical section is arranged about the central tube, thereby forming a radially inner and a radially outer annular chamber, the inner annular chamber is closed on the annular chamber side which is near the cover and remote from the base facing away from the inflow chamber and facing the cover, and both the central tube as well as the hollow cylindrical section terminate at a distance from the cover.

### BACKGROUND OF THE INVENTION

The invention relates to a generic capsule with an interior space, with a base and with a cover arranged opposing this that tightly seals the interior space comprising a beverage powder for the preparation of a portion of a hot brewed beverage, such as coffee, tea or bouillon with the transit of steam, wherein the capsule is characterized in that, in the region of the base, an inflow area restricted from the interior space by a separating wall (that is close to the base and distant from the cover) is provided, that the interior space comprises a central tube that runs in an upright manner with relation to the base, that a hollow cylinder section is arranged around the central tube, thereby forming a radially inner as well as a radially outer annulus, that the inner annulus is sealed on its side facing away from the inflow area and the side facing the cover (that is close to the cover and distant from the base), and that both the central tube as well as the hollow cylinder section end at a distance to the cover.

The invention relates to a generic capsule, namely, a capsule with an interior space, with a base and with a cover arranged opposing this that tightly seals the interior space comprising a beverage powder for the preparation of a portion of a hot brewed beverage, such as coffee, tea or bouillon with the transit of steam. Thereby, the capsule with a circular cross section can be provided with a conical wall between the base and the cover, wherein the level base passes over a truncated cone into the conical wall.

Such a capsule is known, and its use is generally very popular (EP 20 29 457 B1). Thereby, the capsule is inserted into a brewing apparatus, which perforates the cover and opens the base by means of steam lances, via which steam is pressed through the beverage powder, thereby making the hot brewed beverage, which flows out of the capsule through the perforated cover, thereby holding back the beverage power and being directed into a container, for example, a cup.

Thereby, the steam is conveyed in a direction from the base to the cover by means of the beverage powder. For this purpose, a sufficiently high minimum pressure is required in order to obtain the hottest brewed beverage possible on the one hand and, on the other hand, in the case of increasing pressure, the flow rate of the steam is increased, thereby resulting in the beverage power being wetted, however not sufficiently saturated with steam. This is where the invention comes in.

### SUMMARY OF THE INVENTION

The object of the invention is to design a generic capsule in such a way that the beverage power is optimally used for making the brewed beverage.

In the case of a generic capsule, this task is achieved according to the invention by means of its characterizing features, meaning by means of the fact that, in the region of the base, an inflow area restricted from the interior space by a separating wall (that is close to the base and distant from the cover) is provided, that the interior space comprises a central tube that runs in an upright manner with relation to the base, that a hollow cylinder section is arranged around the central tube, thereby forming a radially inner as well as a radially outer annulus, that the inner annulus is sealed on its side facing away from the inflow area and the side facing the cover (close to the cover and distant from the base), and that both the central tube as well as the hollow cylinder section end at a distance to the cover.

Thereby, according to a first embodiment, the invention is characterized in that the central tube is connected to the inflow area on its side near the base and designed to be sealed on the side near the cover and is provided with radial openings there, and the hollow cylinder section is arranged at its end near the base at a distance to the separating wall, thereby leaving a connection of the inner to the outer annulus in addition to each annulus being separated from the inflow area.

In this way, in the case of this embodiment according to the invention, the steam initially moves into the tube section, thereby moving from there to the perforated cover via the inner annulus and then the outer annulus. Due to the deflections, the route of the steam is approximately double as long as is the case with the generic prior art, thereby resulting in a better utilisation of the beverage powder and also resulting in the brewed beverage having a more intensive taste. Thereby, the radially outer annulus can be formed by the wall. Expediently, the capsule can be inserted into the brewing device in a lying position. In the case of the same shape and dimensions as generic versions, the capsule according to the invention can be inserted into the same brewing apparatus used for known capsules and then also be used if their steam lances flow into the inflow area after opening the base.

A capsule is known where steam flows through in the opposite direction than in the case of the invention, namely from the cover to the base (WO2017/068535A1), which comprises a central tube running in an upright manner with relation to the base, of which an open side is sealed from the cover towards the outside, however is open via radial openings towards the inside and is sealed in the direction of its other opposing side by means of an inner closure. At the same time, the base of the capsule is sealed with the other end of the central tube. However, the steam does not flow completely through the central tube, as is the case with the invention. The cover is penetrated by a steam lance and steam is applied to the one open side of the central tube, which enters into the interior space of the capsule via nearby radial openings. Two things happen at the same time: on the one hand, the bellow-like conical wall is pressed together, thereby reducing the height of the capsule; on the other hand, the other end of the central tube is pressed out of the capsule and this is opened in the process so that the brewed beverage can flow out.

### BRIEF DESCRIPTION OF THE DRAWING

A preferred exemplary embodiment of the invention is explained in detail in the following taking the drawing under consideration. The figures show:

FIG. 1 is a first shape of a capsule according to the invention in a schematic half-section and

FIG. 2 is a second form of a capsule according to the invention in a schematic half-section.

### DETAILED DESCRIPTION OF THE INVENTION

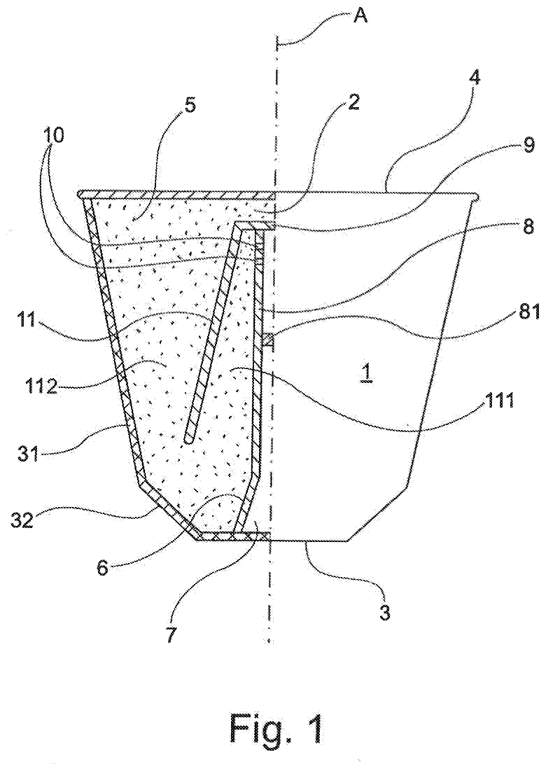

The capsule 1 of the first embodiment in accordance with FIG. 1 which has a circular cross section and is rotationally symmetric with relation to axis A, comprises an interior space 2, which is arranged between a base 3 and a cover 4, which is commonly known, tightly seals the interior space 2 and is arranged in an opposing direction to it. A beverage powder 5 for preparing a portion of a hot brewed beverage, such as coffee, tea or bouillon is located within the interior space 2 with the transit of steam. The capsule 1 is provided with a conical wall 31 between the base 3 and the cover 4, wherein the level base 3 passes over a truncated cone 32 into the conical wall 31.

In the region of the base, an inflow area 7 is provided that is restricted from the interior space 2, which can have any shape, by means of a separating wall 6 that is close to the base and distant from the cover. Furthermore, the interior space 2 comprises a central tube 8 running in an upright manner with relation to the base 3, into which the inflow space 7 flows and the end, which faces away from the inflow area and is located at a distance to the base and close to the cover, is sealed by means of a closure 9. In the first case mentioned, the inflow area 7 can be designed as a section adjoining the central tube thereby having a conical shape. In the second case mentioned, the central tube 9 comprises radial openings 10 in the region that faces away from the inflow area 7 and is distant from the base and close to the cover. Furthermore, the central tube 8 can be provided with a plate 81 as a supply of steam, which can be penetrated by a steam lance of the brewing apparatus during operation in the region between its side that is close to the base and connected to the inflow area 7 and its sealed side 9 that is close to the cover. In the case of this embodiment, the base 3 can be also be designed to be open in the region of the inflow area 7 or the central tube 9.

A hollow cylinder section 11 is arranged around the central tube 8 on the end that faces away from the inflow area and is distance to the base and close to the cover, thereby forming a radially inner 111 as well as a radially outer annulus 112. Thereby, the inner annulus 111 is sealed on its side that faces the cover 4 and faces away from the inflow area 7 and is connected in this way to the outer annulus 112 at its region close to the base at a distance to the separating wall 6, wherein each annulus 111, 112 is separated from the inflow area 7 by the separating wall 6. Both the central tube 8 as well as the hollow cylinder section 11 end at a distance to the cover 4.

These capsule 1 is then inserted into a brewing apparatus, which is commonly known and not shown, wherein the cover 4 is perforated, thereby allowing the brewed beverage to escape, and the base 3 is opened to the inflow area 7 by means of steam lances and, via this, steam is pressed through the beverage power 5 in a direction spanning from the base to the cover, thereby making the hot brewed beverage that flows through the perforation of the cover 4 into a container, for example, a cup, with the beverage powder 5 being held back in the process.

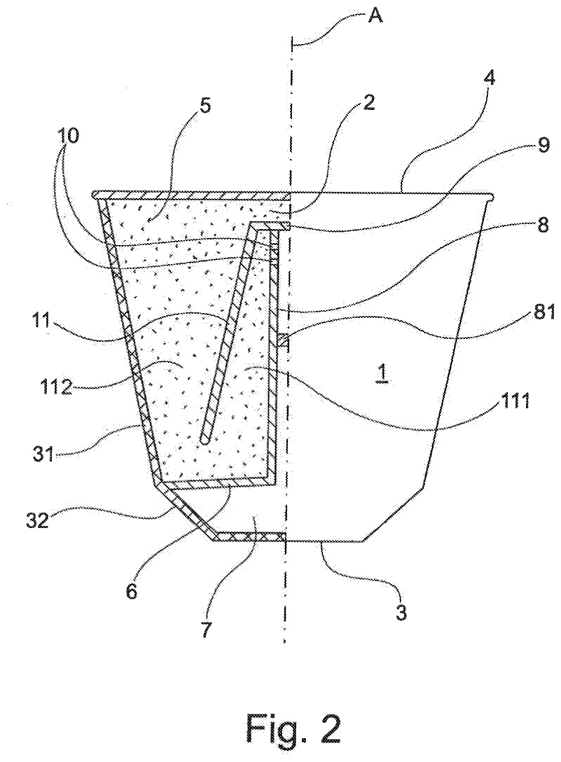

The second embodiment of the capsule according to the invention according to FIG. 2 differs from the first one in that the separating wall 6 is connected to the region of the wall 31 transition to the truncated cone 32, thereby increasing the volume of the inflow area 7, which can be advantageous when introducing steam.

1. The capsule with an interior space, with a base and with a cover arranged opposing this that tightly seals the interior space having a beverage powder for the preparation of a portion of a hot brewed beverage with the transit of steam, wherein, in the region of the base, inflow area restricted from the interior space by a separating wall is provided, that the interior space comprises a central tube that runs in an upright manner with relation to the base, that a hollow cylinder section is arranged around the central tube, thereby forming a radially inner as well as a radially outer annulus, that the inner annulus is sealed on its side facing away from the inflow area and the side facing the cover that is close to the cover and distant from the base, and that both the central tube as well as the hollow cylinder section end at a distance to the cover, and that the central tube on its side close to the base is connected to the inflow area and is sealed on the side close to the cover and is provided with radial openings there, and the hollow cylinder section is arranged both at its end near the base at a distance to the separating wall, thereby leaving a connection of the inner to the outer annulus, as well as each annulus being separated from the inflow area.

2. The capsule according to claim 1, wherein the capsule is configured to be rotationally symmetric with relation to an axis and that the inflow area is intersected by this axis.

3. The capsule according to claim 2, wherein at least one of the central tube, the hollow cylinder section, the separating wall, the conical wall, the inflow area or the truncated cone is configured to be rotationally symmetric with relation to the axis of symmetry of the capsule.

4. The capsule according to claim 3, wherein the inflow area restricted by the separating wall on one side is restricted from the region of the base, which is spaced away from the truncated cone.

5. The capsule according to claim 4, wherein the inflow area is restricted by a circular region on the base, which is spaced away from the truncated cone via a circular ring directly adjoining it.

6. The capsule according to claim 1, wherein the central tube is provided with a plate that can be penetrated within the region between its side connected to the inflow area close to the base and its sealed side close to the cover.

7. The capsule according to claim 6, wherein the penetrable plate is arranged closer to the sealed side close to the cover than to the base.

8. A method of brewing a beverage comprising arranging the capsule according to claim 1 in the brewing apparatus, provided with a steam supply device configured to supply steam into the capsule.

9. The method according to claim 8, wherein the steam supply device is arranged symmetrically with resect to the axis of symmetry of the capsule.

10. The method according to claim 8, wherein the brewing apparatus is provided with only a single steam supply.

11. The method according to claim 8, wherein the steam supply device comprises a steam lance.
